(19) United States
(12) Patent Application Publication
(10) Pub. No.: US 2006/0248037 A1
(43) Pub. Date: Nov. 2, 2006

(54) Annotation of inverted list text indexes using search queries

(75) Inventors: Joerg Meyer, San Jose, CA (US); Jan H. Pieper, San Jose, CA (US); Andrew S. Tomkins, San Jose, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/118,526

(22) Filed: Apr. 29, 2005

(51) Int. Cl. G06F 17/30

(52) U.S. Cl. 707/1

(57) ABSTRACT

A system and method of data mining comprises processing contents of a primary posting index; and producing a posting within a secondary posting index based on the processing of the contents of the primary posting index, wherein the processing of contents of the primary posting index comprises submitting a disjunction of terms or phrases to the primary posting index. The processing of contents of the primary posting index comprises generating a query result by submitting a query to the primary posting index using a query language of the primary posting index. Moreover, the processing of contents of the primary posting index comprises processing the primary posting index in order to generate results, wherein the results comprise a set of candidate entries with additional metadata; and filtering the results in order to produce the posting within the secondary posting index.

### BACKGROUND

1. Field of the Invention

The embodiments of the invention generally relate to information retrieval systems based on inverted list indexes and, more particularly, to data mining and queries run on such systems.

2. Description of the Related Art

Data mining typically involves the process of extracting information such as patterns, relationships, etc. from a large corpus, usually page-by-page, and adding metadata to the corpus. In this context, a corpus is a collection of written texts or spoken language, usually structured in some way to facilitate their automatic processing. In most traditional data mining systems the pages to be indexed are first annotated with metadata, such as entities, and then indexed. Disambiguation is the process used to decide what instance a particular term refers to. For example “Paris” could refer to the city “Paris, France”, the city “Paris, Texas”, the person “Paris Hilton”, etc. Classification is the process of deciding to which class a document belongs. A class can be a grouping of related pages (e.g., commercial, educational, governmental, etc.). A query can be extended with an ‘AND’ or ‘OR’ term that specifies various features of a page which can determine the membership of a certain class. An entity can be understood as something that one refers to with many names or descriptions. However, modifications to the entity definitions in query searches, on-topic/off-topic lists, classifier models, etc. require sustaining the corpus and then building a new index. This may be prohibitive in terms of runtime and resources and requires access to the original corpus. Therefore, there remains a need for a new query technique using query entities, thereby yielding more efficient web searching.

### SUMMARY

In view of the foregoing and embodiment of the invention provides a method of data mining and a program storage device readable by computer, tangibly embodying a program of instructions executable by the computer to perform the method of data mining, wherein the method comprises processing contents of a primary posting index; and producing a posting within a secondary posting index based on the processing of the contents of the primary posting index, wherein the processing of contents of the primary posting index comprises submitting a disjunction of terms or phrases to the primary posting index. The processing of contents of the primary posting index comprises generating a query result by submitting a query to the primary posting index using a query language of the primary posting index. Moreover, the processing of contents of the primary posting index preferably comprises processing the primary posting index in order to generate results, wherein the results comprise a set of candidate entries with additional metadata; and filtering the results in order to produce the posting within the secondary posting index.

Additionally, the processing of the primary posting index preferably comprises (a) receiving, as input, a candidate set of terms and phrases and a supplemental set of terms and phrases; (b) extracting, from the primary posting index, a set of posting entries comprising posting entries corresponding to an occurrence of a term or phrase of the candidate set; posting entries corresponding to an occurrence of a term or phrase from the supplemental set, wherein a document including the term or phrase from the supplemental set includes an occurrence of a term or phrase from the candidate set; and (c) generating a posting list in the secondary posting index by processing resulting posting entries generated during the extracting from the primary posting index.

Alternatively, the processing of the primary posting index may comprise (a) receiving, as input, a candidate set of terms and phrases and a supplemental set of terms and phrases; (b) sending a query to the primary posting index; (c) returning, from the query, result information comprising posting entries corresponding to an occurrence of a term or phrase of the candidate set; and posting entries corresponding to an occurrence of a term or phrase from the supplemental set, wherein a document including the term or phrase from the supplemental set include an occurrence of a term or phrase from the candidate set; and (d) generating a posting list in the secondary posting index by processing resulting posting entries from the primary posting index.

Also, the processing of the primary posting index preferably accepts all phrases deemed topical by a disambiguating classifier given access to locations of all phrases, on-topic terms, and off-topic terms in the primary posting index, wherein a search query to the primary posting index may comprise a disjunct of phrases representing a feature set of the classifier, wherein result postings of the search query are filtered by the classifier to determine which of the postings are accepted into the secondary posting index.

A system of data mining comprising a primary posting index and a secondary posting index comprising a posting, wherein the posting is generated based on a processing of contents of the primary posting index, wherein the processing of contents of the primary posting index comprises submitting a disjunction of terms or phrases to the primary posting index. The processing of contents of the primary posting index comprises a query result generated by submitting a query to the primary posting index using a query language of the primary posting index. The processing of contents of the primary posting index comprises a processor adapted to process the primary posting index in order to generate results, wherein the results comprise a set of candidate entries with additional metadata; and a filter adapted to filter the results in order to produce the posting within the secondary posting index.

The processing of the primary posting index preferably comprises (a) an input candidate set of terms and phrases and a supplemental set of terms and phrases; (b) a set of posting entries extracted from the primary posting index comprising posting entries corresponding to an occurrence of a term or phrase of the candidate set; and posting entries corresponding to an occurrence of a term or phrase from the supplemental set, wherein a document including the term or phrase from the supplemental set includes an occurrence of a term or phrase from the candidate set; and (c) a posting list generated in the secondary posting index by processing resulting posting entries generated during the extracting from the primary posting index.

Alternatively, the processing of the primary posting index may comprise (a) an input candidate set of terms and phrases and a supplemental set of terms and phrases; (b) a query sent to the primary posting index; (c) result information returned from the query comprising posting entries corresponding to an occurrence of a term or phrase of the candidate set; and posting entries corresponding to an occurrence of a term or phrase from the supplemental set, wherein a document including the term or phrase from the supplemental set include an occurrence of a term or phrase from the candidate set; and (d) a posting list generated in the secondary posting index by processing resulting posting entries from the primary posting index.

Furthermore, the processing of the primary posting index preferably accepts all phrases deemed topical by a disambiguating classifier given access to locations of all phrases, on-topic terms, and off-topic terms in the primary posting index, wherein a search query to the primary posting index may comprise a disjunct of phrases representing a feature set of the classifier, wherein result postings of the search query are filtered by the classifier to determine which of the postings are accepted into the secondary posting index.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The embodiments of the invention will be better understood from the following detailed description with reference to the drawings, in which:

FIG. 1 is a schematic diagram of a system flow sequence according to an embodiment of the invention;

FIG. 2 is a schematic diagram illustrating inverted lists according to an embodiment of the invention; and

FIG. 3 is a schematic diagram of a computer system according to an embodiment of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

In the context of the information retrieval aspect of the embodiments of the invention, documents entering a text indexing system are broken into small units corresponding roughly to individual words by a process known as tokenizations; the resulting small units are known as tokens. In this context, a “posting index” is a data structure well-known in the art of information retrieval. This data structure includes one or more postings, each of which is associated with a token. A posting corresponding to a particular token includes information about the occurrences of that token in documents in the corpus. In its most basic form, the posting may include only the identifiers of the documents which include the token. In other embodiments, the posting may include more detailed information such as the location of each occurrence of the token in every document of the corpus, or additional metadata regarding the presentation of the token: large versus small font, bold versus plain typeface, etc. According to the embodiments of the invention, a primary posting index will include postings corresponding to tokens akin to the traditional setting. Moreover, the embodiments of the invention further provide a mechanism to produce a secondary posting index comprising a new set of postings, disjoint from the postings that are present in the primary posting index. As mentioned, there remains a need for a new query technique which disambiguates query entities, thereby yielding more efficient web searching. The embodiments of the invention achieve this by providing a mechanism for producing the postings of the secondary posting index by processing only the primary posting index, and not the documents themselves.

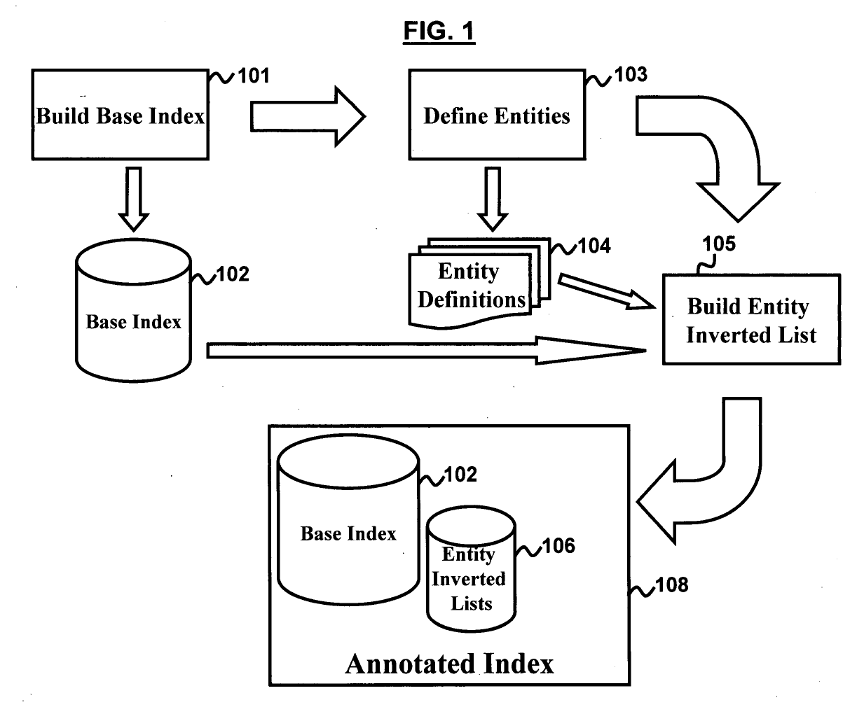

Referring now to the drawings and more particularly to FIGS. 1 through 3 where similar reference characters denote corresponding features consistently throughout the figures, there are shown preferred embodiments of the invention. Generally, as illustrated in FIG. 1, and further described below, the embodiments of the invention provide a technique that first builds (101) a full text search index 102 (primary or base index). A full text index is generally built recording all occurrences of all unique terms of all documents to be indexed. The final result of such a process is a list of unique terms, with each term pointing to a list of those occurrences. An occurrence includes information about the document this occurrence belongs to and where in the document the occurrence is found. Such a process may run on a single computer or a set of computers interconnected through a network. The process may be completely performed in software or aided by special purpose hardware.

Next, queries are defined (103) using predefined entity definitions 104, wherein a query can describe an entity, a disambiguated entity, or a classification query. For example, consider the entity named “USA”. A user may use this entity to refer to all occurrences of the phrases “United States of America, “USA,” and “U.S.”. This set of phrases can then be used to construct an ‘OR’ query. The specific query language to be used may vary based on the indexer used and so long as the indexer understands the concept of a disjunction of index terms and phrases of index terms. These queries are then run against a built base index 102 in order to build (105) an entity inverted list 106. A query processor (not shown) of an indexer then runs the query as defined above and returns all occurrences of all of the terms or phrases that make up the disjunction.

Then, the results of the queries are used to annotate the built base index 102 with one inverted list 106 per query to create an annotated (or secondary) index 108. The list of occurrences returned from running a query is then used to write new inverted lists using the name of the entity as the index term. This process is the same as writing inverted lists during the process of building the base index 102 as previously described. The only difference is the process of extracting the list of occurrences; i.e., from the document versus running a query. Thereafter, the annotated index 108 can be used to access the query results. The base index 102 is now annotated with new index terms, namely the entities. The indexer treats these new index terms like all previously existing terms and can therefore incorporate them during query processing.

Within the context of the embodiments of the invention, an entity can be understood as something that one refers to with many names or descriptions. An entity can be a person, an institution, an organization, a building or a country. All of these have in common the notion that the same thing can be described in different languages, with different names or nicknames or varying short forms of their names. Moreover, an entity can also be expressed as a search query.

For example, the person John Doe may be referred to as “J. Doe”, “John Doe”, “Mr. Doe” or the state of California may be referred to as “California”, “The Golden State”, or “Kalfornien” in German. Clearly, using a text search tool such as web search engines would require an enormous amount of work to do an exhaustive search for an entity because the user would have to cover all possibilities in the search, and often in multiple searches. According to the embodiments of the invention, all variations of the name of an entity could be searched for by using one alias. For example, in order to search for all variations of “California”, an artificial search term such as “Entity::CA” could be used to do such a search. The definition of an entity can be seen as a list of word sequences (phrases). To find all the documents which contain at least one of these phrases, the embodiments of the invention computes the logical ‘OR’ of all those phrases.

In order to accomplish this, a secondary posting index 108 is built by running queries against a primary posting index 102. Hence, a complex query only needs to be executed once. By storing the results of a complex query, these results can be used in future queries using an entity by simply reading one inverted list. For example, an entity can be defined as a disjunction (logical ‘OR’) of tens or even hundreds of phrases. The first time this query is run, all terms and their respective inverted lists that occur in this large number of phrases are processed and condensed into one inverted list for the entity to be defined. If these results are not stored, this process would have to be repeated in any query that wants to use the entity. The resulting posting can then be accessed via an alias from the secondary posting index 108. This occurs because the secondary posting index 108 of entities is represented as the logical ‘OR’ query of all phrases that describe the entity. The entities are preferably combined with text or metadata (e.g., date) to provide a higher level of search; e.g. search for all occurrences of the entity “California” which occurs in the same sentence as the phrase “silicon valley”. This efficiently computes the entity index entries and annotates an existing full text search index, thereby allowing for an efficient search for entities in a full text index by using an alias for the entity as a search term, just like one would use a word from a page.

Accordingly, the process provided by the embodiments of the invention provides an efficient search for complex queries, whereby changes in a query only require a re-run of the particular query instead of re-running all queries. Hence, no access to the original data corpus is required. Changes in definitions only require a re-run of the query for one particular entity definition. Thus, the embodiments of the invention are very favorable in runtime over the existing conventional solutions. Also, entity aliases in the final result index are available for many different searches. For example, a user that wants to search for all pages that contain the entity “USA” and the words “silicon” and “valley”, can now simply form a query which is the conjunction of the index terms “silicon” and “valley” and the newly computed entity alias “USA”. If this were not stored, the user would have to form a query which is the conjunction of the words “silicon” and “valley” and the disjunction of all phrases that define the entity “USA”. Therefore, the process provided by the embodiments of the invention eases the burden on the user to construct such a query as well as the burden on the query processing system in executing the query because fewer terms have to be accessed.

According to the embodiments of the invention, one way of performing disambiguation is using lists of on-topic and off-topic terms. A query can be extended to include on-topic postings, which can then be used to decide whether a specific result positing is actually on-topic or not. Suppose, a user wants to define an entity “jaguar” which refers to the popular car brand. On-topic terms could include names of other car brands, descriptions of car parts, etc. Off-topic terms could include terms such as the Jacksonville Jaguars™, which is a professional football team, or names of other animals. These terms can then be used in the entity query to only return occurrences of any of the definitions (phrases) of the entity “jaguar”, when any of the on-topic terms exist within the document or close to the occurrence of the entity “jaguar”. If any of the off-topic terms exist within the document or near the occurrence of the entity “jaguar”, the occurrence will not be returned as a result.

According to the embodiments of the invention in a full text index, the indexing takes advantage of the fact that many documents share identical tokens (e.g., words or characters). An inverted list index only stores each unique token once while the original set of documents stores it for every page on which it occurs. The storage of the index terms (tokens) and their inverted lists may occur using any one of the well-known techniques to write inverted lists. Therefore, an inverted list index can be seen as a form of compressing the set of documents. The compression ratio depends on the scope of the index. The scope of the index determines whether full positional information is required or whether it is sufficient to simply know that a term occurred within a document and not necessarily where on the page. The embodiments of the invention assume a full positional index; i.e. for every occurrence of a term, it is known in which documents it occurred and where in these documents it occurred. The compression ratio greatly depends on the chosen inverted list format. Furthermore, any particular format for full text indexes is suitable. Moreover, the embodiments of the invention make no assumption on the inverted list format to use. Therefore, compression ratios may vary depending on particular embodiments of the invention.

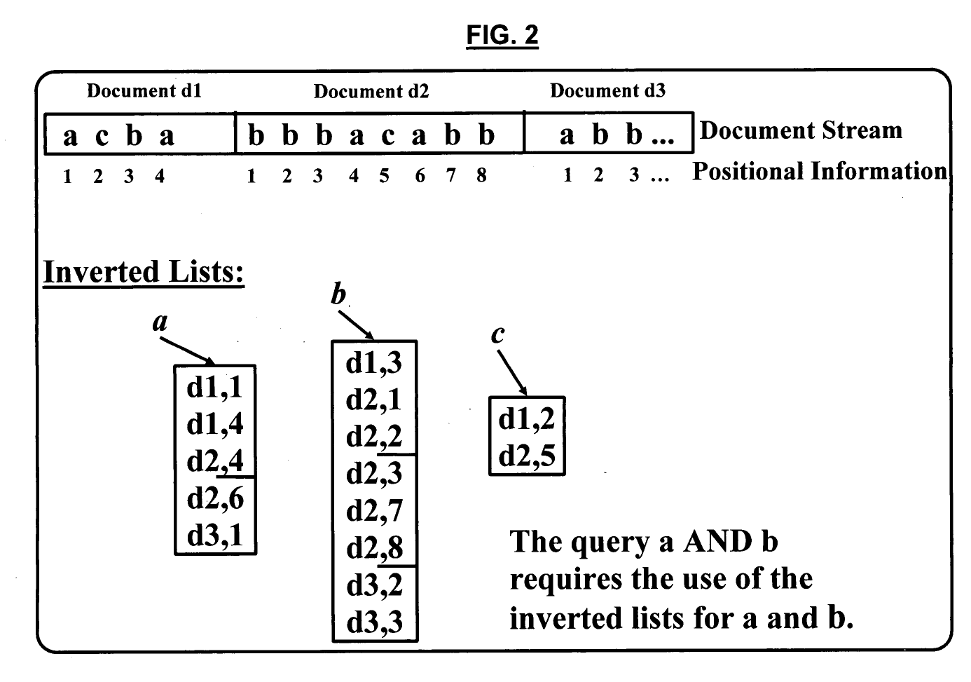

FIG. 2 illustrates an example of inverted lists according to an embodiment of the invention. FIG. 2 shows a set of three documents, d1, d2, and d3. The characters a, b, and c refer to words within these documents. An inverted list indexer (not shown) processes the three documents as follows. The indexer records all the words within a document with their position. This is performed for all documents. In the end, all occurrences of each unique term within all documents are combined in one inverted list per unique term. In order to then answer a query for all documents that contain the words a and b, the query processor only has to refer to the inverted lists for a and b.

A conventional basic inverted index simply records whether a term occurs on page or not, but not how many times or where. Conversely, a full inverted index, as provided by the embodiments of the invention, records every occurrence of every token on every page. While a basic inverted index is more compact in terms of storage, it cannot support searches for sequences of tokens, or the existence of tokens within a certain window of tokens. Thus, a full inverted index allows such sophisticated searches to occur. Between, a basic inverted index and a full inverted index, there are various levels of information that can be stored within an inverted list for a term.

Almost every book has an index, which is basically a generally alphabetical listing of words or sequences of words (e.g., section and chapter headers) at the end of the book, along with page numbers where they are discussed. Using an index, one can avoid performing a page-by-page scan to find pages that contain certain words. Similarly, an inverted list index in the context of information retrieval applications such as web search engines does exactly that. Abstractly, the web is the book, and individual web documents represent the pages in the book. Building an inverted list index may be performed by scanning all documents to be indexed and splitting them into tokens. This process, called parsing or tokenization, produces tokens that can either be words on an English text document, Chinese characters, or 4 byte numbers, for example.

The embodiments of the invention can take the form of an entirely hardware embodiment, an entirely software embodiment, or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

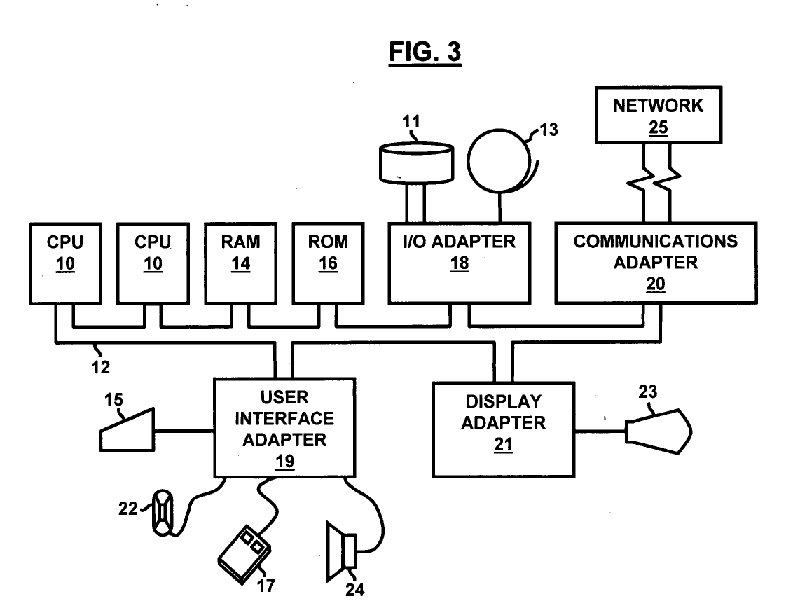

A representative hardware environment for practicing the embodiments of the invention is depicted in FIG. 3. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

According to the embodiments of the invention, a query against a full text index is the same as the intersection/join (depends on query operators; e.g., ‘OR’, ‘AND’) of the inverted lists of all the query terms. The query result is therefore an inverted list itself. For each term of the query, an inverted list needs to be accessed. The embodiments of the invention are able to perform efficient data mining operations by building a secondary posting index through queries against a full text index, which correspondingly reduces the cost for data mining. Again, no access to the original corpus is necessary.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of data mining, said method comprising:
processing contents of a primary posting index; and
producing a posting within a secondary posting index based on the processing of said contents of said primary posting index.

2. The method of claim 1, wherein the processing of contents of said primary posting index comprises submitting a disjunction of terms or phrases to said primary posting index.

3. The method of claim 1, wherein the processing of contents of said primary posting index comprises generating a query result by submitting a query to said primary posting index using a query language of said primary posting index.

4. The method of claim 1, wherein the processing of contents of said primary posting index comprises:
processing said primary posting index in order to generate results, wherein said results comprise a set of candidate entries with additional metadata; and
filtering said results in order to produce said posting within said secondary posting index.

5. The method of claim 1, wherein the processing of said primary posting index comprises:
receiving, as input, a candidate set of terms and phrases and a supplemental set of terms and phrases;
extracting, from said primary posting index, a set of posting entries comprising:
posting entries corresponding to an occurrence of a term or phrase of said candidate set; and
posting entries corresponding to an occurrence of a term or phrase from said supplemental set, wherein a document including said term or phrase from said supplemental set includes an occurrence of a term or phrase from said candidate set;
generating a posting list in said secondary posting index by processing resulting posting entries generated during said extracting from said primary posting index.

6. The method of claim 1, wherein the processing of said primary posting index comprises:
receiving, as input, a candidate set of terms and phrases and a supplemental set of terms and phrases;
sending a query to said primary posting index;
returning, from said query, result information comprising:
posting entries corresponding to an occurrence of a term or phrase of said candidate set; and
posting entries corresponding to an occurrence of a term or phrase from said supplemental set, wherein a document including said term or phrase from said supplemental set include an occurrence of a term or phrase from said candidate set;
generating a posting list in said secondary posting index by processing resulting posting entries from said primary posting index.

7. The method of claim 1, wherein the processing of said primary posting index accepts all phrases deemed topical by a disambiguating classifier given access to locations of all phrases, on-topic terms, and off-topic terms in said primary posting index.

8. The method of claim 7, wherein a search query to said primary posting index comprises a disjunct of phrases representing a feature set of said classifier, wherein result postings of said search query are filtered by said classifier to determine which of the postings are accepted into said secondary posting index.

9. A program storage device readable by computer, tangibly embodying a program of instructions executable by said computer to perform a method of data mining, said method comprising:
processing contents of a primary posting index; and
producing a posting within a secondary posting index based on the processing of said contents of said primary posting index.

10. The program storage device of claim 9, wherein in said method, the processing of contents of said primary posting index comprises submitting a disjunction of terms or phrases to said primary posting index.

11. The program storage device of claim 9, wherein in said method, the processing of contents of said primary posting index comprises generating a query result by submitting a query to said primary posting index using a query language of said primary posting index.

12. The program storage device of claim 9, wherein in said method, the processing of contents of said primary posting index comprises:
processing said primary posting index in order to generate results, wherein said results comprise a set of candidate entries with additional metadata; and
filtering said results in order to produce said posting within said secondary posting index.

13. The program storage device of claim 9, wherein in said method, the processing of said primary posting index comprises:
receiving, as input, a candidate set of terms and phrases and a supplemental set of terms and phrases;
extracting, from said primary posting index, a set of posting entries comprising:
posting entries corresponding to an occurrence of a term or phrase of said candidate set; and
posting entries corresponding to an occurrence of a term or phrase from said supplemental set, wherein a document including said term or phrase from said supplemental set includes an occurrence of a term or phrase from said candidate set;
generating a posting list in said secondary posting index by processing resulting posting entries generated during said extracting from said primary posting index.

14. The program storage device of claim 9, wherein in said method, the processing of said primary posting index comprises:
receiving, as input, a candidate set of terms and phrases and a supplemental set of terms and phrases;
sending a query to said primary posting index;
returning, from said query, result information comprising:
posting entries corresponding to an occurrence of a term or phrase of said candidate set; and
posting entries corresponding to an occurrence of a term or phrase from said supplemental set, wherein a document including said term or phrase from said supplemental set include an occurrence of a term or phrase from said candidate set;
generating a posting list in said secondary posting index by processing resulting posting entries from said primary posting index.

15. The program storage device of claim 9, wherein in said method, the processing of said primary posting index accepts all phrases deemed topical by a disambiguating classifier given access to locations of all phrases, on-topic terms, and off-topic terms in said primary posting index.

16. The program storage device of claim 15, wherein a search query to said primary posting index comprises a disjunct of phrases representing a feature set of said classifier, wherein result postings of said search query are filtered by said classifier to determine which of the postings are accepted into said secondary posting index.

17. A system of data mining comprising:
a primary posting index; and
a secondary posting index comprising a posting, wherein said posting is generated based on a processing of contents of said primary posting index.

18. The system of claim 17, wherein the processing of contents of said primary posting index comprises a disjunction of terms or phrases submitted to said primary posting index.

19. The system of claim 17, wherein the processing of contents of said primary posting index comprises a query result generated by submitting a query to said primary posting index using a query language of said primary posting index.

20. The system of claim 17, wherein the processing of contents of said primary posting index comprises:
a processor adapted to process said primary posting index in order to generate results, wherein said results comprise a set of candidate entries with additional metadata; and
a filter adapted to filter said results in order to produce said posting within said secondary posting index.

21. The system of claim 17, wherein the processing of said primary posting index comprises:
an input candidate set of terms and phrases and a supplemental set of terms and phrases;
a set of posting entries extracted from said primary posting index comprising:
posting entries corresponding to an occurrence of a term or phrase of said candidate set; and
posting entries corresponding to an occurrence of a term or phrase from said supplemental set, wherein a document including said term or phrase from said supplemental set includes an occurrence of a term or phrase from said candidate set;
a posting list generated in said secondary posting index by processing resulting posting entries generated during said extracting from said primary posting index.

22. The system of claim 17, wherein the processing of said primary posting index comprises:
an input candidate set of terms and phrases and a supplemental set of terms and phrases;
a query sent to said primary posting index;
result information returned from said query comprising:
posting entries corresponding to an occurrence of a term or phrase of said candidate set; and
posting entries corresponding to an occurrence of a term or phrase from said supplemental set, wherein a document including said term or phrase from said supplemental set include an occurrence of a term or phrase from said candidate set;
a posting list generated in said secondary posting index by processing resulting posting entries from said primary posting index.

23. The system of claim 17, wherein the processing of said primary posting index accepts all phrases deemed topical by a disambiguating classifier given access to locations of all phrases, on-topic terms, and off-topic terms in said primary posting index.

24. The system of claim 23, wherein a search query to said primary posting index comprises a disjunct of phrases representing a feature set of said classifier, wherein result postings of said search query are filtered by said classifier to determine which of the postings are accepted into said secondary posting index.
